(19) United States
(12) Patent Application Publication
(10) Pub. No.: US 2009/0147638 A1
(43) Pub. Date: Jun. 11, 2009

(54) OPTICAL DISC REPRODUCING APPARATUS

(76) Inventors: Yoshikazu TADOKORO, Osaka (JP); Noriaki Sasaki, Osaka (JP)

Correspondence Address: MCDERMOTT WILL & EMERY LLP, 600 13TH STREET, NW, WASHINGTON, DC, 20005-3096, US

(21) Appl. No.: 12/328,301

(22) Filed: Dec. 4, 2008

(30) Foreign Application Priority Data
Dec. 6, 2007 (JP) 2007-315510
Aug. 25, 2008 (JP) 2008-215277

(51) Int. Cl. G11B 7/00

(52) U.S. Cl. 369/47.14; G9B/7

(57) ABSTRACT

In an optical disc reproducing apparatus, when an amount of light received by an optical pick-up varies or leakage light enters a light receiving portion due to the tilt of the optical pick-up or the like, a tracking control signal generation circuit adds an offset in accordance with a control value outputted from a tracking actuator controller to an output of a tracking servo filter. As a result, a tracking servo pull-in operation is performed in a state where the optical pick-up is forcibly tilted. The direction in which the optical pick-up mentioned above is forcibly tilted is determined from the result of, e.g., measuring the duty ratio of a DPD off-track signal. Therefore, a reproduction signal, a focus error signal, and a tracking error signal are correctly generated without providing a tilt mechanism in the optical pick-up.

### CROSS REFERENCE TO RELATED APPLICATIONS

This Non-Provisional application claims priority under 35 U.S.C. §119(a) on Patent Application No. 2007-315510 filed in Japan on Dec. 6, 2007 and Patent Application No. 2008-215277 filed in Japan on Aug. 25, 2008, the entire contents of which are hereby incorporated by reference.

### BACKGROUND

The present disclosure relates to an optical disc reproducing apparatus and, more particularly, to a method for controlling an optical pick-up.

FIG. 1 shows a block diagram of a conventional optical disc reproducing apparatus for an optical disc or the like. In the drawing, laser light is emitted from an optical pick-up 1 to an optical disc 2, and the reflected light is detected by the optical pick-up 1. By inputting the detected reflected light to a reproduction signal processing circuit 4, and controlling a focus control circuit 7 and a tracking control circuit 10 in accordance with an input signal, a signal can be read from the optical disc 2.

The focus control circuit 7 performs a control function of focusing the laser light emitted from the optical pick-up 1 on the recording surface of the optical disc 2. The control function is referred to as focus-on control, and a state in which the laser light is controlled to be focused on the recording surface of the optical disc 2 is referred to as a focus follow-up state.

The tracking control circuit 10 performs a control function of tilting the optical pick-up 1 such that the laser light emitted from the optical pick-up 1 follows the track of the optical disc 2. The control function is referred to as tracking-on control, and a state where the focused laser light follows the track of the optical disc 2 is referred to as a tracking follow-up state. In addition, a period where both of a focus servo and a tracking servo are in the respective follow-up states is generally referred to as a servo follow-up period.

When the laser light emitted from the optical pick-up 1 to the optical disc 2 is received by the optical pick-up 1, the reflected light is most easily received, and the influence of leakage light is minimized in a state where the laser light is emitted perpendicularly to the optical disc 2. Therefore, it is possible to achieve improvements in the qualities of an error signal and a reproduction signal. However, due to factors such as the tilt of the optical disc 2 or the optical pick-up 1 and fabrication variations, the laser light emitted from the optical pick-up 1 to the optical disc 2 is not necessarily perpendicular to the optical disc 2. When the laser light cannot be emitted perpendicularly due to the tilt of the optical pick-up 1 or the like, the amount of light received by the optical pick-up 1 varies or leakage light undesirably enters a light receiving portion so that the S/N ratio of the reproduction signal or the error signal conceivably deteriorates. A description will be given hereinbelow to an exemplary case where a tracking error signal generated using a typical Differential Phase Detection cannot be generated correctly due to the influence of leakage light or the like. However, this is only exemplary, and does not limit the scope of the present invention to the tracking error signal generated by the Differential Phase Detection.

FIG. 2 shows a circuit which generates a tracking error signal using a typical Differential Phase Detection. When it is assumed that the reflected light detected by a light receiving element 13, the reflected light detected by a light receiving element 14, the reflected light detected by a light receiving element 15, and the reflected light detected by a light receiving element 16 are A, B, C, and D, an addition signal between the reflected light A and the reflected light C and an addition signal between the reflected light B and the reflected light D are determined, and then binarized using binarized signal generation circuits 17 and 18 to be inputted to a phase-difference detection circuit 19. In this manner, the phase difference between a signal (A+C) and a signal (B+D) are detected, and a phase difference output detected by the method described above is assumed to be a DPD tracking error signal.

FIG. 3 shows a process of generating a DPD tracking error signal when there is no influence of leakage light or variations in the light receiving elements. FIG. 4 shows a process of generating a DPD tracking error signal when the amount of the reflected light C detected by the light receiving element 15 is extremely reduced by leakage light or variations in the light receiving elements. In the case of FIG. 4, the reflected light C is extremely weak so that a difference occurs between the result of an arithmetic operation for the signal (A+C) in the case of FIG. 4 and that in the case of FIG. 3. As a result, a difference occurs between a phase difference output (DPD tracking error signal) produced when there is no influence of leakage light and that produced when a difference occurs in the amount of the reflected light.

FIG. 5 shows a process of generating a DPD tracking error signal when noise is superimposed on the reflected light C detected by the light receiving element 15 due to the influence of leakage light or variations in the light receiving elements. Since noise is superimposed on the reflected light C, a difference occurs between the result of the arithmetic operation for the signal (A+C) in the case of FIG. 5 and that in the case of FIG. 3. As a result, a difference occurs between a phase difference output (DPD tracking error signal) produced when there is no influence of leakage light and that produced when noise is superimposed on the reflected light due to the influence of leakage light.

From the foregoing example, it can be understood that a difference occurs in a signal (error signal or reproduction signal) generated from the reflected light when leakage light affects the amount of the reflected light or the S/N ratio of the reflected light.

In the conventional optical disc reproducing apparatus, a tilt correction mechanism 3 is incorporated in the optical pick-up 1, as shown in FIG. 2, so as to adjust the angle of the optical pick-up to a value at which the laser light is emitted substantially perpendicularly to the optical disc 2. In this manner, the influence of leakage light is reduced to prevent reductions in reproduction performance and the S/N ratio of the error signal. Such a technology is disclosed in Japanese Unexamined Patent Publication No. HEI 10-172162 as an optical pick-up including a tilt correction means for automatically correcting the tilt of an objective lens relative to an optical disc so as to allow light emission to the optical disc at an optimum emission angle.

By using the optical pick-up 1 equipped with the conventional tilt mechanism 3, it is possible to reduce the influence of leakage light on the optical pick-up.

However, for the purpose of reducing the cost of an optical pick-up, optical disc reproducing apparatus each using an optical pick-up which is not equipped with the tilt correction mechanism 3 have increased in number in recent years. When reproduction from an optical disc is to be performed using such an optical pick-up, the influence of leakage light cannot be ignored. Therefore, when the optical pick-up significantly tilts during a tracking servo pull-in operation or during a tracking follow-up operation, a reduction in the S/N ratio of the reproduction signal or fluctuations in error signal cannot be avoided, which may cause playability degradation or servo unstabilization.

### SUMMARY

It is therefore an object of this disclosure to reduce, in an optical disc reproducing apparatus, a reduction in the S/N ratio of a reproduction signal or fluctuations in error signal without mounting an anti-leakage-light means such as a tilt correction mechanism therein, and thereby achieve playability improvement and servo stabilization.

To attain the object, a presently-disclosed tracking servo pull-in operation or a tracking servo follow-up operation is performed in an optical disc reproducing apparatus, while an optical pick-up is forcibly tilted in a direction in which the influence of leakage light is reduced without mounting an anti-leakage-light means such as a tilt correction mechanism therein.

Specifically, an optical disc reproducing apparatus of this disclosure includes: an optical pick-up for emitting laser light to an optical disc, and receiving the reflected light; a tracking error signal generation circuit for generating a tracking error signal from a signal resulting from the light received by the optical pick-up; a tracking servo filter for modulating a frequency of the tracking error signal to generate a control signal for driving a tracking actuator of the optical pick-up from the tracking error signal; a tracking actuator controller for outputting a control value for adding an offset to an output of the tracking servo filter; a tracking control signal generation circuit for generating a tracking actuator control signal based on the output of the tracking servo filter and on the control value from the tracking actuator controller; a DPD off-track signal generation circuit for generating a DPD off-track signal based on the tracking error signal by a Differential Phase Detection; and an actuator tilt detection circuit for sensing a direction of tilt of the tracking actuator, wherein the tracking control signal generation circuit adds the offset in accordance with the control value outputted from the tracking actuator controller to control the optical pick-up into a state where the optical pick-up is tilted, and performs a tracking servo pull-in operation.

In an embodiment of the optical disc reproducing apparatus, the tracking control signal generation circuit adds the offset in accordance with the control value outputted from the tracking actuator controller to also perform a tracking servo follow-up operation in the state where the optical pick-up is tilted.

In an embodiment of the optical disc reproducing apparatus, the tracking control signal generation circuit adds the offset in accordance with the control value outputted from the tracking actuator controller to an output of the tracking control signal generation circuit in accordance with the output of the tracking servo filter, measures a duty ratio of the DPD off-track signal generated by the DPD off-track signal generation circuit in the state where the optical pick-up is tilted, and determines the direction of the tilt of the optical pick-up in which influence of leakage light increases.

An embodiment of the optical disc reproducing apparatus further includes: a focus error signal generation circuit for generating a focus error signal from the signal resulting from the light received by the optical pick-up, wherein the servo pull-in operation is performed using the focus error signal generated by the focus error signal generation circuit.

In an embodiment of the optical disc reproducing apparatus, the servo pull-in operation is performed using the tracking error signal generated by the tracking error signal generation circuit.

An embodiment of the optical disc reproducing apparatus further includes: a focus error signal generation circuit for generating a focus error signal from the signal resulting from the light received by the optical pick-up, wherein the servo follow-up operation is performed using the focus error signal generated by the focus error signal generation circuit.

In an embodiment of the optical disc reproducing apparatus, the servo follow-up operation is performed using the tracking error signal generated by the tracking error signal generation circuit.

An embodiment of the optical disc reproducing apparatus further includes: a reproduction signal processing circuit for generating a reproduction signal from the signal resulting from the light received by the optical pick-up, wherein the servo pull-in operation is performed using the reproduction signal generated by the reproduction signal processing circuit.

Thus, in accordance with this disclosure, even in an optical disc reproducing apparatus using an optical pick-up in which an anti-leakage-light means such as a tilt correction mechanism is not provided, and the influence of leakage light is unignorable, a tracking servo pull-in operation or a tracking servo follow-up operation is performed, while the tracking actuator controller tilts the optical pick-up in a direction in which the influence of leakage light is reduced. As a result, the focus error signal and the tracking error signal can be generated correctly during the servo pull-in operation to allow the stabilization of a focus drive follow-up operation during a tracking servo pull-in period and the stabilization of the tracking servo pull-in operation, while also allowing the stabilization of the focus error signal, the tracking error signal, and the reproduction signal (RF signal) during the tracking servo follow-up operation. As a result, it is possible to stabilize the focus servo follow-up operation during a tracking servo follow-up period, stabilize the tracking servo follow-up operation, reduce the jitter of the reproduction signal, and improve the S/N ratio. Therefore, the reproducing ability of the optical disc reproducing apparatus can be improved.

### BRIEF DESCRIPTION OF THE DRAWINGS

FIG. 1 is an overall block diagram of a conventional optical disc reproducing apparatus;

FIG. 2 is a view showing a structure of a DPD tracking error signal generation circuit provided in the conventional optical disc reproducing apparatus;

FIG. 3 is a view showing a process of generating a DPD tracking error signal in the conventional optical disc reproducing apparatus;

FIG. 4 is a view showing a process of generating a DPD tracking error signal when the detection level of one of four signals lowers;

FIG. 5 is a view showing a process of generating a DPD tracking error signal when noise is superimposed on one of the four signals;

FIG. 6 is a view showing an overall block structure of an optical disc reproducing apparatus according to this disclosure of the present invention;

FIG. 7 is a view illustrating a tracking servo pull-in operation;

FIG. 8 is a view showing a tracking error signal and a tracking actuator control signal when an eccentric disc is followed;

FIG. 9 is a view showing a tracking error signal and a tracking actuator control signal when the servo pull-in operation is performed, while an optical pick-up is tilted in an inner circumferential direction;

FIG. 10 is a view showing a tracking error signal and a tracking actuator control signal when noise is superimposed due to the influence of leakage light;

FIG. 11 is a view showing a tracking signal and a tracking actuator control signal when the influence of leakage light is reduced in the optical disc reproducing apparatus according to the first embodiment;

FIG. 12 is a view showing the relationship between a control value outputted from a tracking actuator controller and an offset;

FIG. 13 is a view showing a DPD off-rack signal when there is no influence of leakage light;

FIG. 14 is a view showing the DPD off-track signal when there is the influence of leakage light;

FIG. 15 is a view showing a focus error signal and the like when anti-leakage-light measures are adopted in the optical disc reproducing apparatus according to the first embodiment;

FIG. 16 is a view showing a tracking error signal and a tracking actuator control signal during a servo follow-up operation when the anti-leakage-light measures are adopted in the optical disc reproducing apparatus;

FIG. 17 is a view showing a focus error signal and a tracking actuator control signal during the servo follow-up operation when the anti-leakage-light measures are adopted in the optical disc reproducing apparatus;

FIG. 18 is a view showing a reproduction signal (RF signal) on which noise is superimposed due to the influence of leakage light; and

FIG. 19 is a view showing a reproduction signal (RF signal) which is normally generated due to the anti-leakage-light measures adopted in the optical disc reproducing apparatus according to the first embodiment.

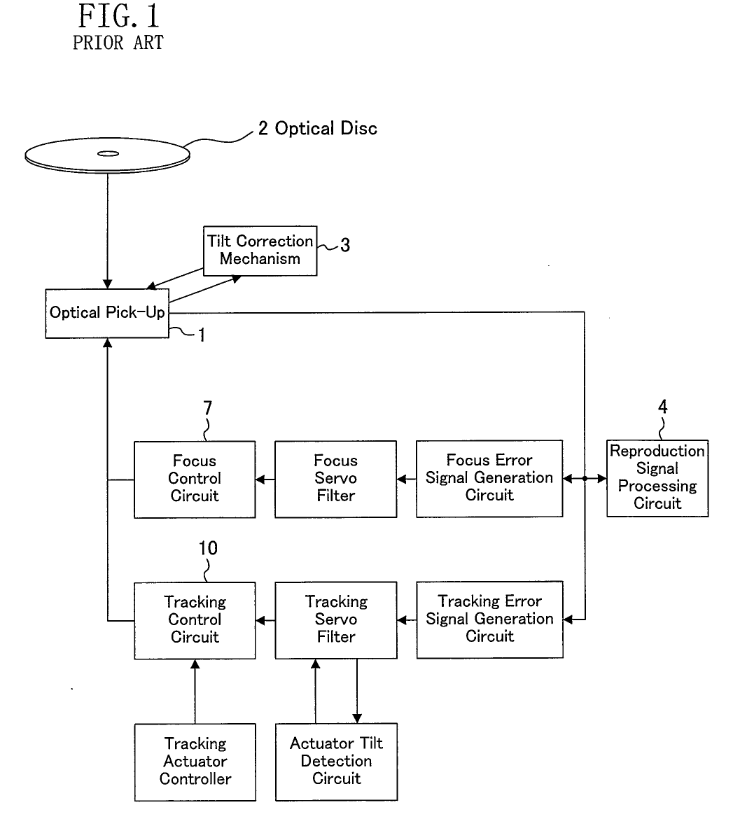

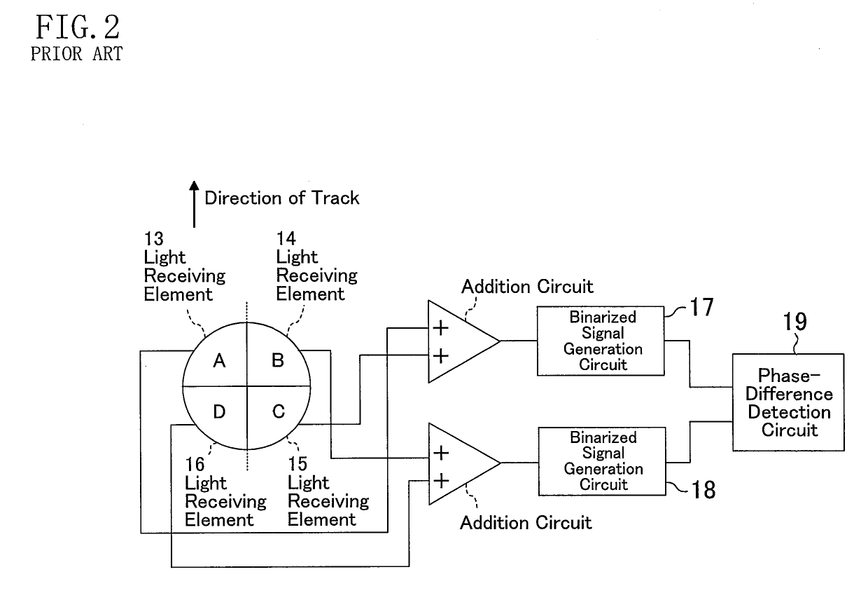

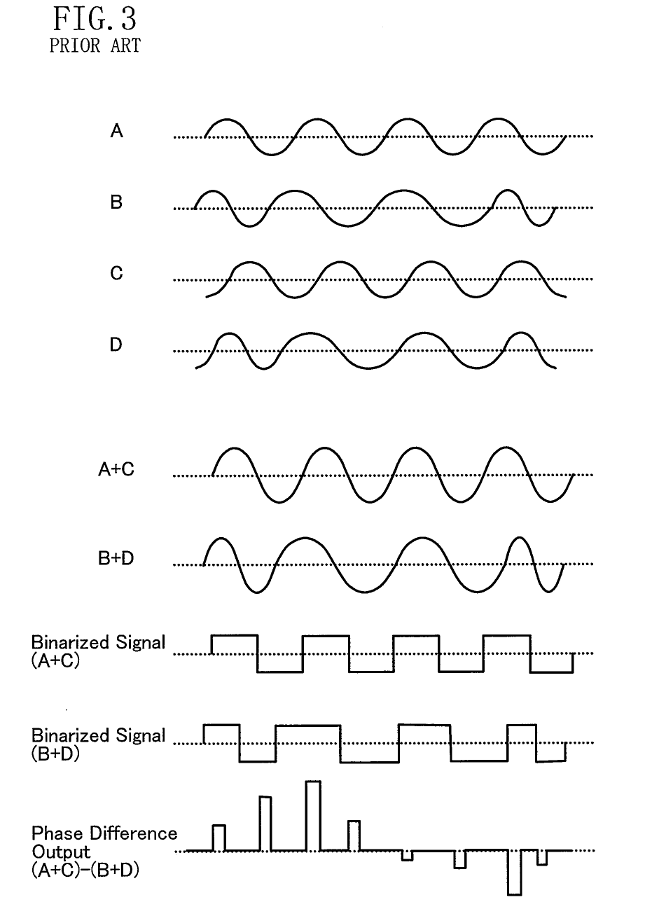

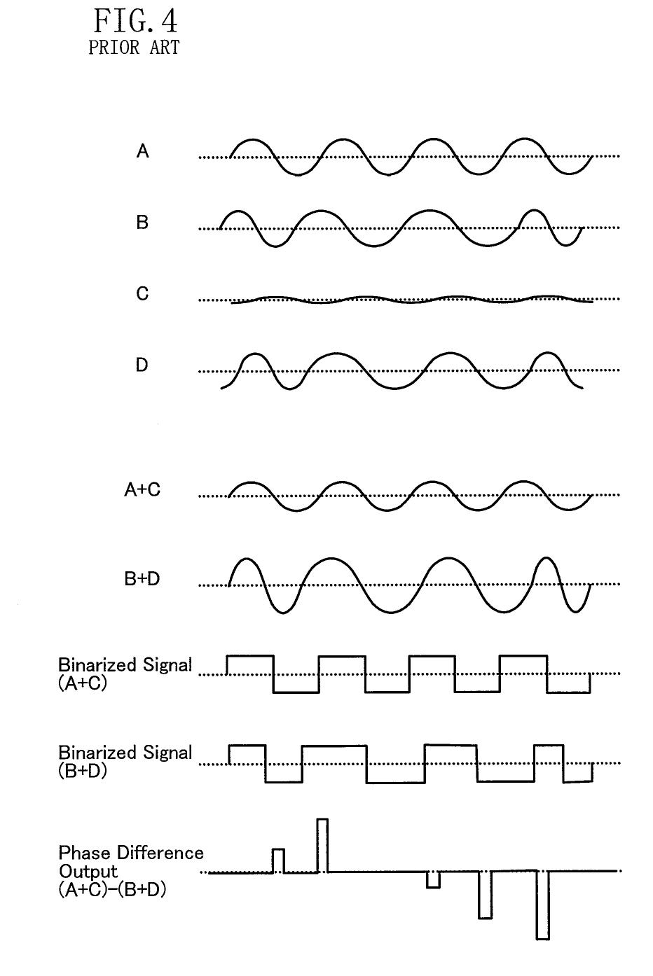

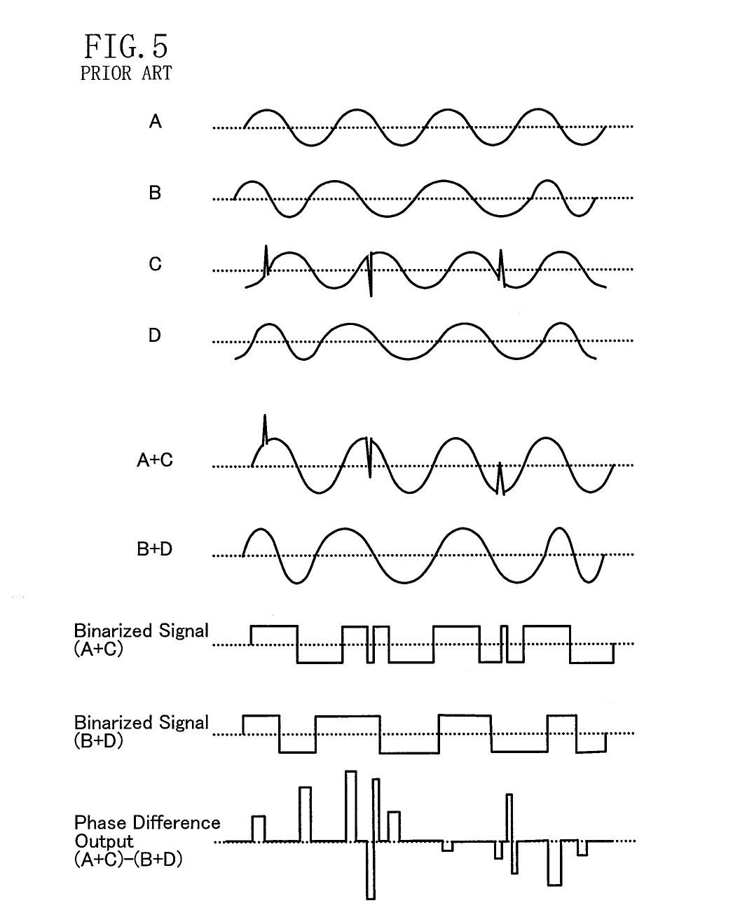

### DETAILED DESCRIPTION

Referring now to the drawings, each preferred embodiment of the present invention will be described hereinbelow.

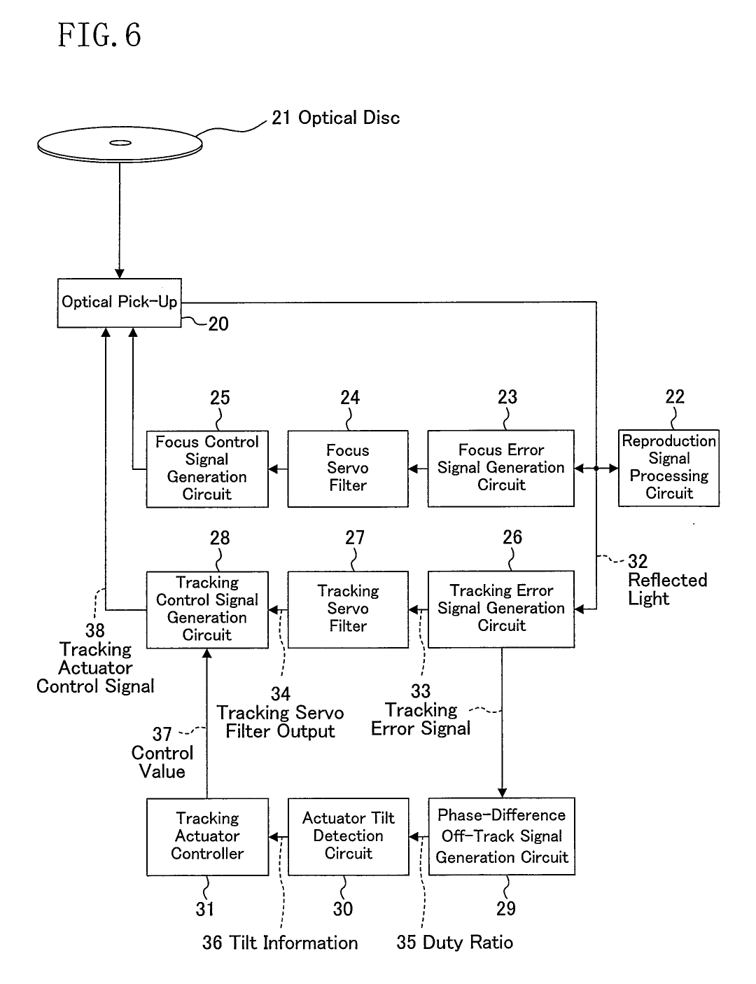

FIG. 6 shows a block diagram of the embodiment of the present invention. In FIG. 6, laser light is emitted from an optical pick-up 20 to an optical disc 21, and reflected light 32 is detected by the optical pick-up 20. By inputting the detected reflected light 32 to a reproduction signal processing circuit 22 and analyzing it, reproduced data can be read from the optical disc 21.

On the other hand, the reflected light 32 for generating an error signal, which is detected by the optical pick-up 20, is inputted to a focus error signal generation circuit 23 and to a tracking error signal generation circuit 26 to generate a focus error signal and a tracking error signal 33. The focus error signal is inputted to a focus servo filter 24, and converted to a focus actuator control signal, which is transmitted to the focus actuator of the optical pick-up 20 through the focus control signal generation circuit 25 to control the focus actuator. Likewise, in a tracking system also, a tracking servo filter 27 modulates the frequency of a tracking error signal 33 to provide a tracking servo filter output 34. A tracking control signal generation circuit 28 converts the tracking servo filter output 34 to a tracking actuator control signal 38 by adding an offset thereto based on a control value 37 for the application of the offset which is outputted from a tracking actuator controller 31. The tracking actuator control signal 38 is transmitted to the tracking actuator of the optical pick-up 20 to drive control the tracking actuator of the optical pick-up 20. On the other hand, the tracking error signal 33 is inputted to a DPD off-track signal generation circuit 29 to generate a DPD off-track signal.

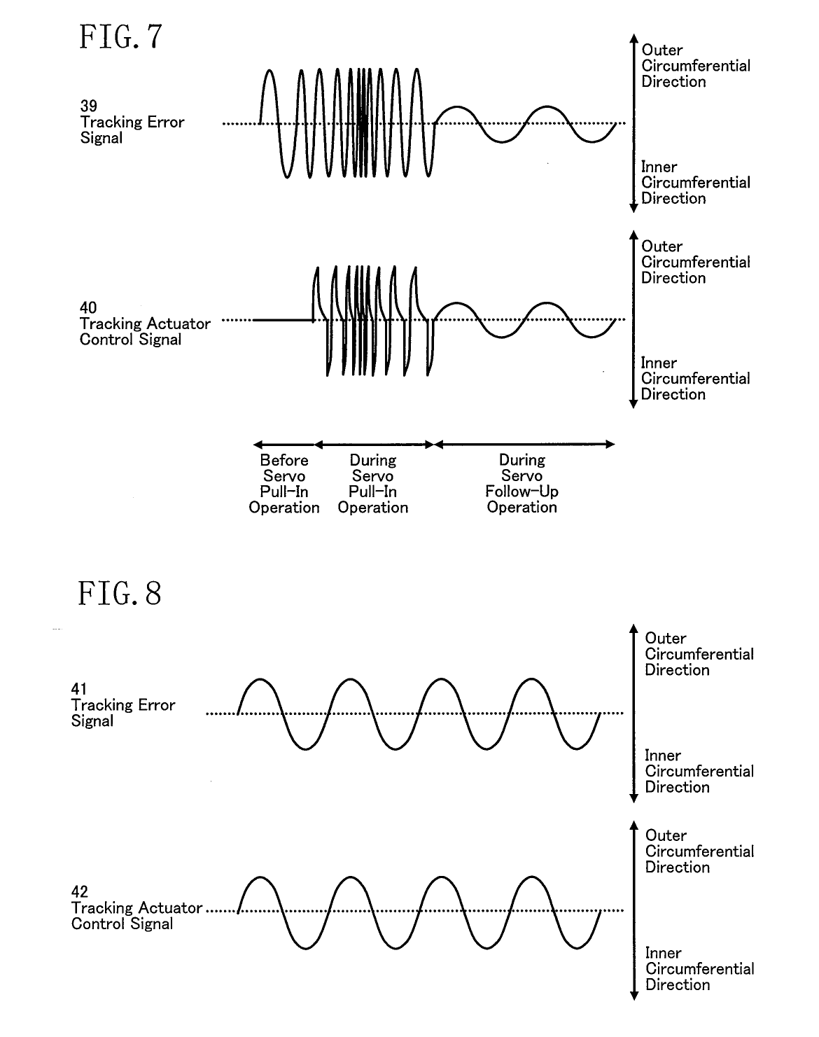

Operations for activating the optical disc 21 include a tracking servo pull-in operation. FIG. 7 shows a typical tracking servo pull-in operation during a tracking servo pull-in period. In the drawing, during the servo pull-in operation, a tracking actuator control signal 40 is controlled to delay the period of a tracking error signal 39, i.e., reduce a track crossing speed to a level at which a tracking follow-up operation is easily performed. In this manner, a state where the tracking actuator is capable of following a track is established, and the tracking servo is caused to follow the tracking error signal 39.

FIG. 8 shows a tracking error signal and a tracking actuator control signal when an eccentric disc is followed. In the drawing, the amplitude of a tracking error signal 41 during the tracking servo follow-up operation is accordingly larger with a disc with eccentricity than with a standard disc without eccentricity because the tracking servo is caused to follow the eccentricity. Therefore, a tracking actuator control signal 42 while following the eccentricity similarly has an accordingly larger amplitude since it is caused to follow the eccentricity. In addition, because the optical pick-up 20 is likely to be tilted during a tracking pull-in operation immediately after a seek operation or the like, the tracking servo pull-in operation may be performed in a state where the optical pick-up 20 is tilted.

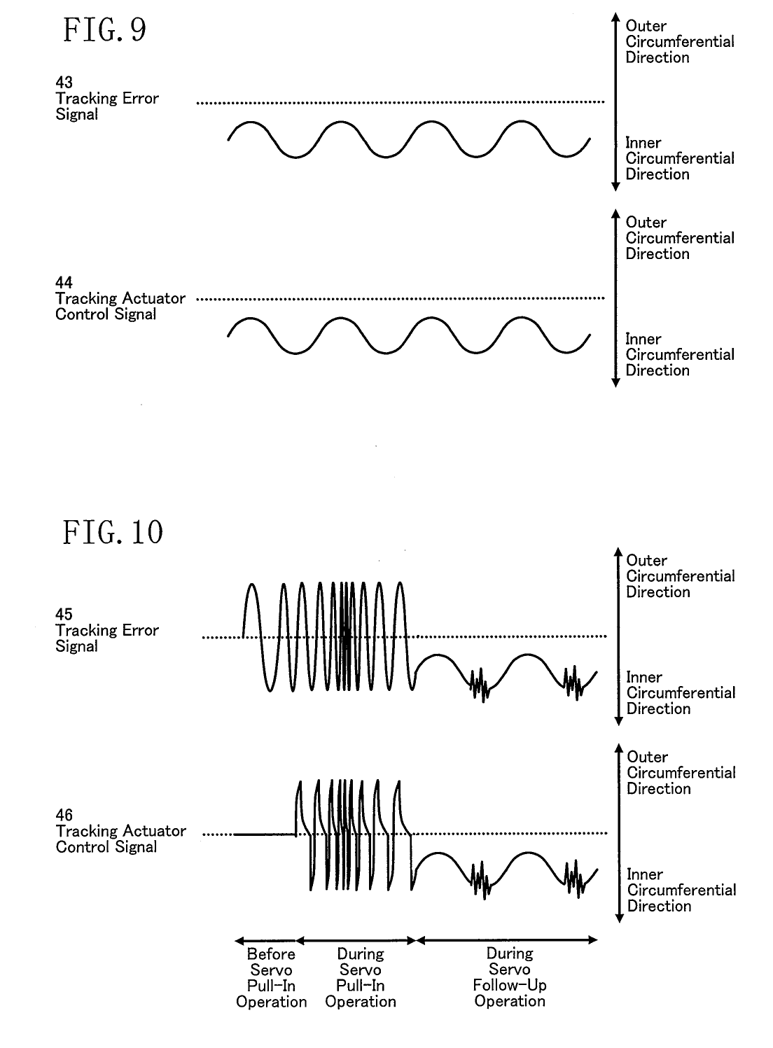

FIG. 9 shows a tracking error signal 43 and a tracking actuator control signal 44 when the tracking servo pull-in operation is performed in the state where the optical pick-up 20 is tilted. Since the servo pull-in operation has been performed in the state where the optical pick-up 20 is tilted, the servo follow-up operation is performed in a state where the tracking error signal 43 and the tracking actuator control signal 44 during the servo follow-up operation or period are largely deviated from the center positions. As a result, it may take a time to return the tracking error signal 43 and the tracking actuator control signal 44 to the center positions.

When the optical pick-up is not equipped with a tilt correction mechanism for a cost reduction, leakage light exerts great influence on the optical pickup 20 when it is tilted due to the influence of eccentricity as described above or due to the state during the tracking pull-in operation. This causes the superimposition of noise on the error signal or the reproduction signal, or a reduction in S/N ratio.

FIG. 10 shows a tracking error signal 45 and a tracking actuator control signal 46 when the tracking pull-in operation is performed with respect to an eccentric disc in the optical disc reproducing apparatus using the optical pick-up in which the influence of leakage light is unignorable particularly when the optical pick-up is tilted in an inner circumferential direction. Since the tracking servo pull-in operation has been performed in the state where the optical pick-up is tilted in the inner circumferential direction during the tracking pull-in operation, noise is superimposed on the tracking error signal 45 due to the influence of leakage light every time the optical pick-up is tilted in the inner circumferential direction during the subsequent tracking servo follow-up operation. As a result, the tracking actuator control signal 46 follows the tracking error signal 45 on which the noise mentioned above is superimposed so that noise is also superimposed on the tracking actuator control signal 46. This degrades the stability of the tracking servo pull-in operation and focus/tracking servo follow-up operations.

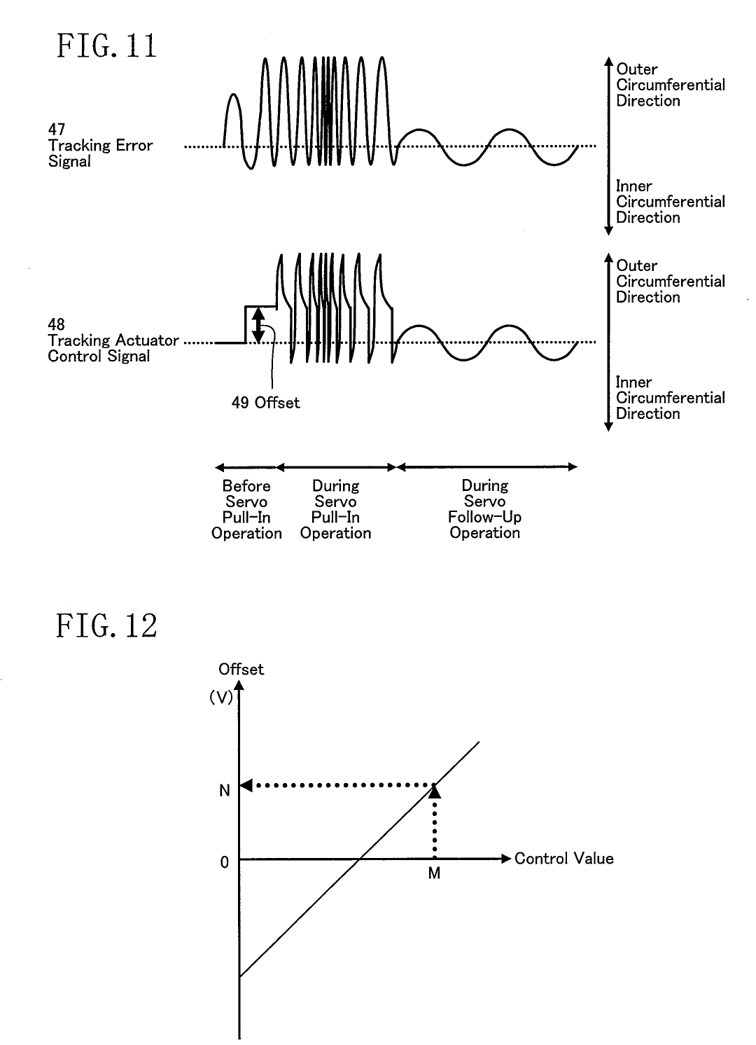

FIG. 11 shows a method for circumventing this problem. For example, a method for circumventing the problem when the optical pick-up in which the influence of leakage light is unignorable when it is extremely tilted in the inner circumferential direction, as described above, will be shown hereinbelow. In this case, an offset 49 is applied in advance to the tracking actuator control signal 48 so that the tracking actuator controller 31 shown in FIG. 6 performs the tracking servo pull-in operation in a state where the optical pick-up 20 is forcibly tilted in an outer circumferential direction.

FIG. 12 shows an example of the relationship between the control value 37 outputted from the tracking actuator controller 31 and the offset 49. In accordance with the control value (parameter) outputted from the tracking actuator controller 31, the tracking control signal generation circuit 28 converts the control value 37 mentioned above to the offset (voltage) 49. The offset 49 can be determined as follows through the conversion of the control value 37 using a factor a when the control value is M, and the offset is N(V):

N(V)=α×M.

As for a method for determining the factor a, it is largely dependent on a generation scheme for a tracking error signal, a system configuration, and the control parameter so that a value optimum to a system is determined in advance.

By the method described above, the tracking control signal generation circuit 28 converts the control value 37 outputted from the tracking actuator controller 31 to the offset 49, and applies the offset 49 to an output of the tracking servo filter 27. With an amount of the offset applied by the tracking control signal generation circuit 28, i.e., the control value 37 outputted from the tracking actuator controller 31, it becomes possible to control the optical pick-up 20 by forcibly tilting it in the inner circumferential direction or the outer circumferential direction.

Since the tracking servo pull-in operation is initiated in a state where the optical pick-up 20 is tilted in the outer circumferential direction, the optical pick-up 20 is less likely to be tilted in the inner circumferential direction during the tracking servo pull-in operation. Therefore, it is possible to reduce the influence of leakage light resulting from the tilting of the optical pick-up 20 in the inner circumferential direction during the tracking servo pull-in operation or immediately after the pull-in operation.

In addition, by continuously applying the offset 49 to the tracking servo even during the servo follow-up operation, or changing the parameter related to the tracking follow-up operation, it is possible to control the optical pick-up 20 so as not to tilt it in the inner circumferential direction, and reduce the influence of leakage light during the servo follow-up operation.

Although the example described above has assumed the case where the influence of leakage light is unignorable when the optical pick-up 20 is extremely tilted in the inner circumferential direction, the same holds true even in the case where the influence of leakage light is unignorable when the optical pick-up is extremely tilted in the outer circumferential direction. At this time, the influence of leakage light can be reduced by applying the offset so as not to tilt the optical pick-up 20 in the outer circumferential direction, or changing the parameter for the servo follow-up operation so as to render the optical pick-up 20 less likely to be tilted in the outer circumferential direction during the servo follow-up operation.

Whether the direction in which the influence of leakage light increases is the direction in which the optical pick-up 20 is tilted in the inner circumferential direction or the direction in which the optical pick-up 20 is tilted in the outer circumferential direction can be detected using a method which will be described hereinbelow.

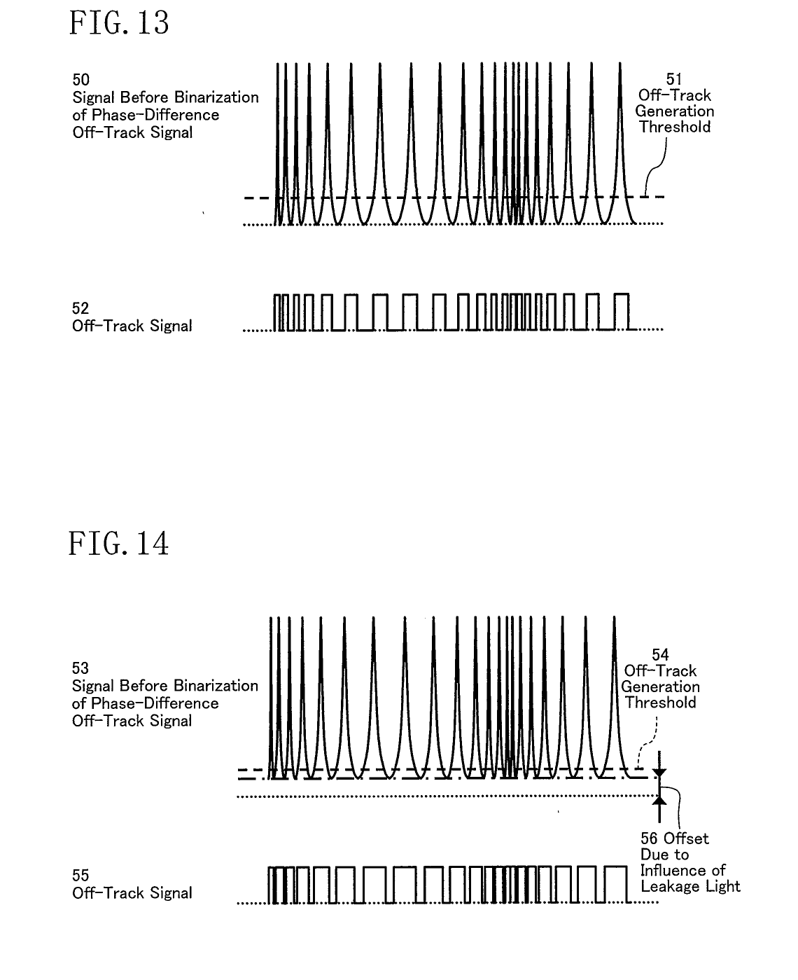

FIG. 13 shows a method for generating the DPD off-track signal in a state where the optical pick-up 20 is not tilted. The signal 50 before binarization of the DPD off-track signal shown in the drawing is obtained by squaring a tracking error signal generated by a Differential Phase Detection. The DPD off-track signal generation circuit 29 shown in FIG. 6 generates a DPD off-track signal 52 by binarizing the signal 50 before binarization of the DPD off-track signal with an off-track generation threshold 51.

FIG. 14 shows the generation of the DPD off-track signal in the state where the optical pick-up 20 is tiled in the inner circumferential direction or the outer circumferential direction. When the optical pick-up 20 is tilted in the inner circumferential direction or the outer circumferential direction, the S/N ratio of the reflected light 32 used for generating the error signal is reduced due to the influence of leakage light, or a difference occurs between the respective amplitudes of a plurality of the signals each for generating the error signal due to variations in the light receiving elements. As a result, the phase difference cannot be detected correctly so that an offset 56 is superimposed on the pre-binarization DPD off-track signal 53.

When a DPD off-rack signal 55 is generated with an off-track generation threshold 54 on the same level as when the DPD off-track signal is generated in the state where the optical pick-up 20 is not tilted, a difference occurs between the duty ratio (High/Low ratios) of the DPD off-track signal 52 when the optical pick-up 20 is not tilted and that of the DPD off-track signal 55 when the optical pick-up 20 is tilted. That is, by measuring the respective duty ratios of the DPD off-track signal 52 in the state where the optical pick-up 20 is not tilted and those of the DPD off-track signals 55 in the state where the optical pick-up 20 is tilted in the inner circumferential direction and the outer circumferential direction, and examining the direction in which the duty ratio deteriorates when the optical pick-up 20 is tilted in either the inner circumferential direction or the outer circumferential direction, it is possible to examine the direction of the tilt of the optical pick-up in which the influence of leakage light is larger.

As an example of means for determining the offset 49 applied to the tracking control signal generation circuit 28 to tilt the optical pick-up 20, a method will be listed which utilizes the duty ratio 35 of the DPD off-track signal 55 measured by the method described above.

When it is assumed that the amount of deviation of the duty ratio 35 mentioned above is X (it is assumed that the amount of deviation when the duty ratio is 50% is 0, the amount of deviation when the duty ratio is 0% is −50, and the amount of deviation when the duty ratio is 100% is +50), and the control value 37 outputted from the tracking actuator controller 31 is Y, the control value 37 can be determined using a factor β as follows:

Y=62 ×X.

As for a method for determining the factor β, it is largely dependent on the method of generating the tracking error signal, the system configuration, and the control parameter so that a value optimum to the system is determined in advance.

By using a signal obtained by converting the control value Y detected by the method described above to the offset N(V), and applying the offset to the tracking servo filter output 34 as the tracking actuator control signal 38 to control the tracking actuator, the tracking actuator controller 31 performs the tracking pull-in operation, while tilting the optical pick-up 20 in the direction opposite to the direction of tilt in which the influence of leakage light is larger. Since this allows a reduction in the influence of leakage light, it becomes possible to correctly generate the error signal during the tracking pull-in operation, and stabilize the tracking servo operation during a tracking pull-in period.

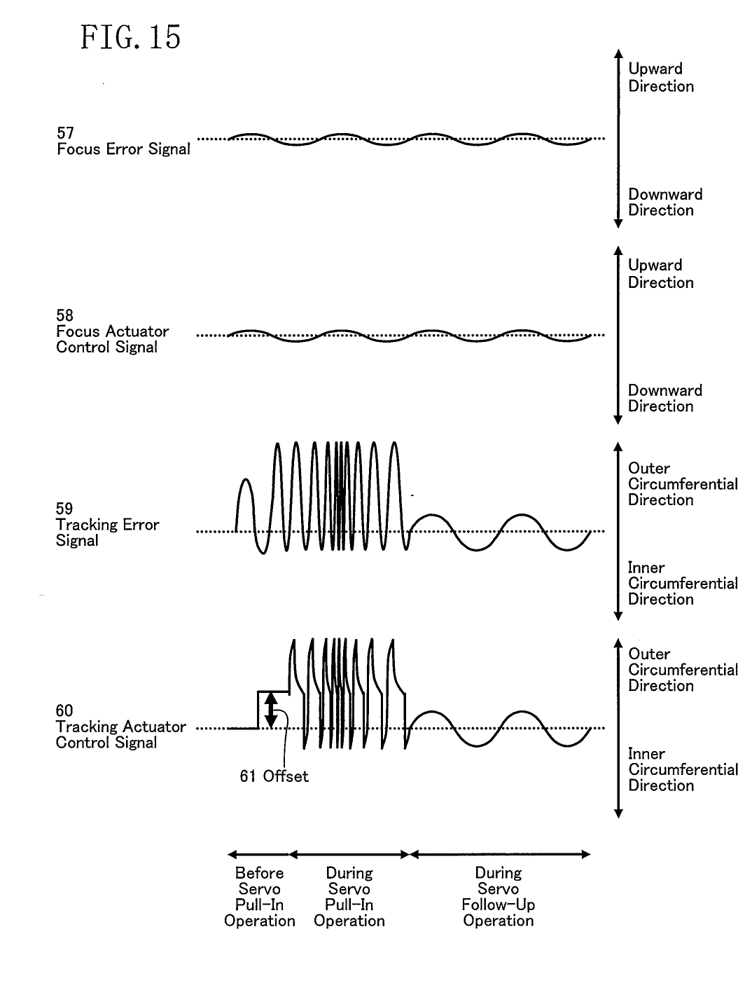

FIG. 15 shows a focus error signal 57 and a focus actuator control signal 58 when the influence of leakage light is reduced by performing the tracking pull-in operation in the optical disc reproducing apparatus using the optical pick-up 20 in which the influence of leakage light is unignorable, while tilting the optical pick-up 20 in the direction in which the influence of leakage light is reduced. Since the influence of leakage light can be reduced by the method described above, it becomes possible to correctly generate the focus error signal 57, stabilize the focus actuator control signal 58, and stabilize the focus servo operation during the tracking pull-in period.

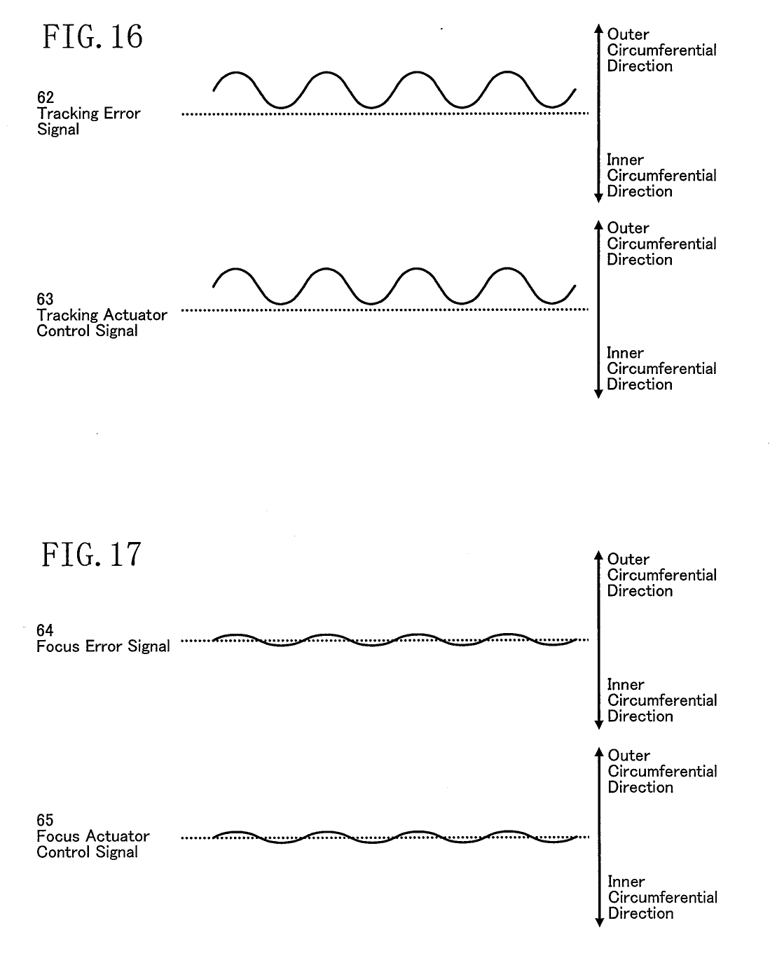

FIG. 16 shows a tracking error signal 62 and a tracking actuator control signal 63 in the optical disc reproducing apparatus in which the anti-leakage-light measures have been adopted. When the tracking servo pull-in operation is ended and the tracking servo follow-up state is entered, the tracking actuator controller 31 changes the parameter for the tracking servo follow-up operation or continuously outputs the control value 37 for applying the offset to the tracking servo to allow the tracking servo follow-up operation, while tilting the optical pick-up 20 in the direction opposite to the direction of tilt in which the influence of leakage light is larger, which has been detected by the method described above. As a result, it becomes possible to correctly generate the tracking error signal 62 during the tracking servo follow-up operation, stabilize the tracking actuator control signal 63, and stabilize tracking servo follow-up performance during the tracking-servo follow-up operation.

FIG. 17 shows a focus error signal 64 and a focus actuator control signal 65 in the optical disc reproducing apparatus in which the anti-leakage-light measures mentioned above have been adopted. When the tracking servo pull-in operation is ended and the tracking servo follow-up state is entered, the tracking actuator controller 31 changes the parameter for the tracking servo follow-up operation or continuously outputs the control value 37 for applying the offset to the tracking servo to allow the tracking servo follow-up operation, while tilting the optical pick-up 20 in the direction opposite to the direction of tilt in which the influence of leakage light is larger, which has been detected by the method described above. As a result, it becomes possible to correctly generate the focus error signal 64, stabilize the focus actuator control signal 65, and stabilize the tracking servo follow-up performance during the tracking servo follow-up operation.

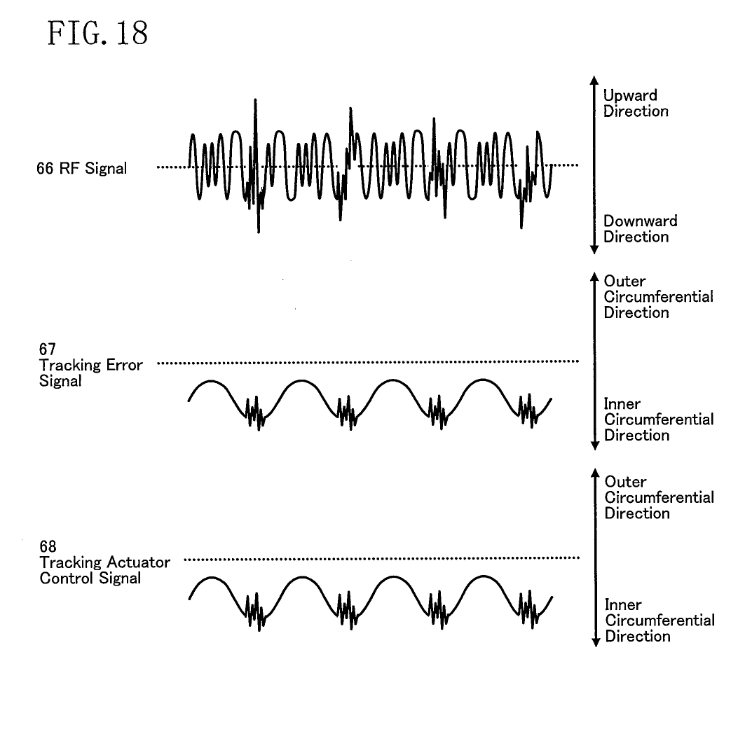

FIG. 18 shows the superimposition of noise on a reproduction signal (RF signal) 66 due to the influence of leakage light in the optical disc reproducing apparatus having the optical pick-up in which the influence of leakage light is unignorable. Since the influence of leakage light is superimposed on the reproduction signal, the phenomena of increased jitter, and a higher error rate occur to result in the degraded reproduction performance of the optical disc apparatus.

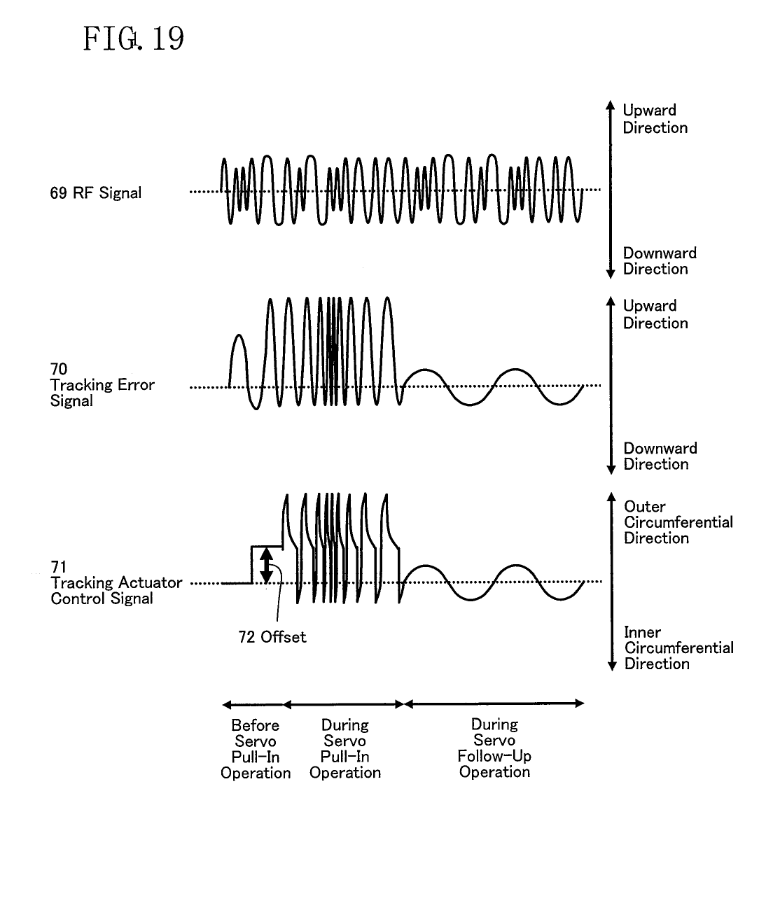

FIG. 19 shows a reproduction signal (RF signal) 69 in the optical disc reproducing apparatus in which the anti-leakage-light measures mentioned above have been adopted. By adopting the anti-leakage-light measures mentioned above, it becomes possible to correctly generate the reproduction signal (RF signal) 69 during the tracking servo follow-up operation when the tracking servo enters the follow-up state, and consequently reduce the jitter of the reproduction signal (RF signal) 69 and improve the S/N ratio during the tracking servo follow-up operation. As a result, the reproducing ability of the optical disc reproducing apparatus can be improved.

Although the method of applying the offset to the tracking control signal generation circuit 28 and the method of changing the parameter for the tracking servo follow-up operation have been described as the means for causing the focus servo and the tracking servo to perform the respective follow-up operations, while tilting the optical pick-up 20 during the follow-up operations in the embodiment, the present invention does not limit the means for causing the focus servo and the tracking servo to perform the respective follow-up operations, while tilting the optical pick-up, to the two types described above. In short, it is sufficient to provide a structure in which the tracking actuator controller 31 outputs the control value 37 for applying the offset to the output of the tracking servo filter 27, and the tracking control signal generation circuit 28 generates the tracking actuator control signal based on the output of the tracking servo filter 27 mentioned above and on the control value 37 of the tracking actuator controller 31 mentioned above.

What is claimed is:

1. An optical disc reproducing apparatus comprising:
an optical pick-up for emitting laser light to an optical disc, and receiving the reflected light;
a tracking error signal generation circuit for generating a tracking error signal from a signal resulting from the light received by the optical pick-up;
a tracking servo filter for modulating a frequency of the tracking error signal to generate a control signal for driving a tracking actuator of the optical pick-up from the tracking error signal;
a tracking actuator controller for outputting a control value for adding an offset to an output of the tracking servo filter;
a tracking control signal generation circuit for generating a tracking actuator control signal based on the output of the tracking servo filter and on the control value from the tracking actuator controller;
a DPD off-track signal generation circuit for generating a DPD off-track signal based on the tracking error signal by a Differential Phase Detection; and
an actuator tilt detection circuit for sensing a direction of tilt of the tracking actuator, wherein
the tracking control signal generation circuit adds the offset in accordance with the control value outputted from the tracking actuator controller to control the optical pick-up into a state where it is tilted, and performs a tracking servo pull-in operation.

2. The optical disc reproducing apparatus of claim 1, wherein the tracking control signal generation circuit adds the offset in accordance with the control value outputted from the tracking actuator controller to also perform a tracking servo follow-up operation in the state where the optical pick-up is tilted.

3. The optical disc reproducing apparatus of claim 1, wherein the tracking control signal generation circuit adds the offset in accordance with the control value outputted from the tracking actuator controller to an output of the tracking control signal generation circuit in accordance with the output of the tracking servo filter, measures a duty ratio of the DPD off-track signal generated by the DPD off-track signal generation circuit in the state where the optical pick-up is tilted, and determines the direction of the tilt of the optical pick-up in which influence of leakage light increases.

4. The optical disc reproducing apparatus of claim 1, further comprising:
a focus error signal generation circuit for generating a focus error signal from the signal resulting from the light received by the optical pick-up, wherein
the servo pull-in operation is performed using the focus error signal generated by the focus error signal generation circuit.

5. The optical disc reproducing apparatus of claim 1, wherein the servo pull-in operation is performed using the tracking error signal generated by the tracking error signal generation circuit.

6. The optical disc reproducing apparatus of claim 2, further comprising:
a focus error signal generation circuit for generating a focus error signal from the signal resulting from the light received by the optical pick-up, wherein
the servo follow-up operation is performed using the focus error signal generated by the focus error signal generation circuit.

7. The optical disc reproducing apparatus of claim 2, wherein the servo follow-up operation is performed using the tracking error signal generated by the tracking error signal generation circuit.

8. The optical disc reproducing apparatus of claim 2, further comprising:
a reproduction signal processing circuit for generating a reproduction signal from the signal resulting from the light received by the optical pick-up, wherein
the servo pull-in operation is performed using the reproduction signal generated by the reproduction signal processing circuit.
